(19) United States
(12) Patent Application Publication
(10) Pub. No.: US 2026/0220806 A1
(43) Pub. Date: Jul. 30, 2026

(54) METHOD FOR DETECTING THE POSITION OF CONTAINERS

(71) Applicant: SIDEL PARTICIPATIONS, Octeville-sur-Mer (FR)

(72) Inventors: Damien CIRETTE, CORCELLES-LES-CITEAUX (FR); Alexander NISTOR, CORCELLES-LES-CITEAUX (FR)

(21) Appl. No.: 19/141,793

(22) PCT Filed: Dec. 19, 2023
(86) PCT No.: PCT/EP2023/086769

§ 371 Date: Jun. 20, 2025

(30) Foreign Application Priority Data
Dec. 21, 2022 (FR) FR2214149

(51) Int. Cl. G06T 7/66; G06T 5/50

(52) U.S. Cl. CPC G06T 7/66; G06T 5/50; G06T 2207/20212

(57) ABSTRACT

One aspect of the invention relates to a computer-implemented method (20) for detecting the position of a plurality of containers (14), each container (14) comprising an upper surface (141), the method comprising:—acquiring (21) at least one image (I1) of the plurality of containers (14);—obtaining (23) local bit patterns (I2) in the acquired image (I1) on the basis of a dimension of the upper surface (141) of each container (14) of the plurality of containers (I4), the dimension of the upper surface (141) of each container (14) being calculated on the basis of a predefined upper surface size (141) of the containers (14);—applying (24) a colour mask to the acquired image (I1) on the basis of a predefined upper surface colour (141) of the containers (14) to obtain a masked image (I3);—combining (25) the partially masked image (I3) and the local bit patterns (I2) to obtain sets of pixels representing the upper

### TECHNICAL FIELD OF THE INVENTION

The technical field of the invention is that of detecting containers, preferably on container packaging lines.

The present invention concerns a method for detecting the position of containers and in particular for detecting their position by detecting an upper surface of each container knowing its size and its color.

### TECHNOLOGICAL BACKGROUND OF THE INVENTION

On container packaging lines the containers are fed between different processing stations by conveyor belts.

In the context of the present invention the term “container” encompasses an individual object intended to contain, non-exhaustively, a fluid, a liquid, powders or granules, notably of agroalimentary or cosmetic type. Such a container can be a bottle or a flask or a carton or a can. A container can be made of any type of material, notably a plastic material, metal or glass. A container can be rigid or semi-rigid depending on its shape and its material.

Furthermore, a container can have any type of shape, symmetrical or not, regular or irregular. Also, a container can have a rounded section, of circular or oval overall shape, or a polygonal section, notably a rectangular or square section.

In particular, such a container includes a bottom that can be flat or substantially flat, or conversely including one or more cavities, as is the case for example of a can with a concave bottom or a bottle with a so-called “petaloid” bottom.

In known manner, containers on an industrial line can undergo a plurality of successive different processes such as production of the container, for example during a plastic injection molding or stretch-blow molding operation in the case of a plastic material bottle, followed by filling and then closing by a cap and labelling. On completion of these processes the containers are termed “finished”.

For handling them such containers are packaged in batches.

Each batch includes a group of containers assembled in a matrix arrangement in columns and rows, generally of globally parallelepipedal shape, often square or rectangular shape. For example a common batch groups together six containers in two rows and three columns.

During these various steps the containers are transported along the production line in a direction of movement extending longitudinally from upstream to downstream between and in various stations dedicated to each process that the containers must undergo. Such transportation can be effected by means of at least one conveyor installation.

Conveying is effected by moving the containers with their bottom resting directly on the upper face of one or more conveyors. This upper face is mobile, forming a belt, generally in the form of one or more endless belts wound around at least one motorized roller.

The containers can be transported along a production line loose in bulk, i.e. with the containers positioned in a quincunx arrangement and in a disorderly manner, notably one against the others over all or part of the width of a conveyor. With a view to specific processing of the containers, such as packaging them, it is necessary to order the bulk flow of containers into a plurality of files, notably to group them downstream and then to package containers from the multiple files in the form of batches.

Such an operation is effected using means for aligning the containers taking the overall form of a funnel positioned above the conveyor enabling reception at its inlet of the bulk flow of said containers and aligning them in a plurality of parallel files delivered to the outlet. Such alignment means include vertical plates mounted on a chassis and spaced in such a manner as to form corridors. Furthermore, the corridors converge from the upstream end to the downstream end, becoming closer together in the direction of movement of the containers.

Thus at the inlet the flow of loose containers is separated in contact with the upstream end of each of the plates and the containers swerve laterally on either side to enter each corridor. As they move forward the convergence in each corridor forms a bottleneck obliging the bottles to take up positions one behind the other, notably by friction against the walls of the plates and by rolling and friction between the containers as they move forward along the corridor.

In particular, the decreasing width of the corridor is configured as a function of the number of containers to be received at the inlet so as to be channeled to obtain an outlet flow with files one or more containers wide as a function of the format of said containers, notably their diameter.

A disadvantage of such a funnel-type aligner is recurring jamming of the containers at the inlet of and inside the corridors. Indeed, the conveying speed in combination with the decreasing width of the corridors often leads to frontal positioning of two containers that causes them to jam, notably because of the friction between the products and against the walls of the plates. It is then necessary to stop the conveyor in order to free the products, notably by manual intervention by an operative: this is a tedious operation and reaching the containers to be freed is precarious. A jam also leads to a loss of production and therefore to a reduction of the efficiency of the line.

To prevent these container jams some solutions propose to detect the position of the containers by supervised learning. To this end a video camera is used and the position of the containers is obtained from an automatic learning algorithm using a model driven by annotated data. By obtaining the position of the container these solutions make it possible to deduce its speed and therefore to predict future jams. A disadvantage of such solutions is that it necessitates manual annotation of the position of each container in a plurality of images. At the time of changing container, packaging line and/or video camera new annotated data has to be fed into the model and new annotations therefore have to be made by an operative.

Thus there is a need for a simple solution enabling the positions of containers on packaging lines to be obtained without necessitating complex annotation operations at the time of changes of the format or of the nature of the containers.

### SUMMARY OF THE INVENTION

The invention offers a solution to the problems referred to above by proposing detection of container positions by image processing requiring no annotation and few hardware resources.

One aspect of the invention concerns a computer-implemented method of detecting the position of a plurality of containers, each container including an upper face, the method including:
acquiring at least one image of the plurality of containers,
obtaining local binary patterns of the acquired image on the basis of a dimension of the upper face of each container of the plurality of containers, the dimension of the upper face of each container being calculated on the basis of a predefined size of the upper face of the containers,
applying a color mask to the acquired image on the basis of a predefined color of the upper face of the containers to obtain a partially masked image,
combining the partially masked image and the local binary patterns to obtain sets of pixels representing the upper faces of the containers,
calculating centers of gravity of the sets of pixels representing the upper faces of the containers of the plurality of containers to obtain the position of each upper face of a container.

Thanks to the invention a position of the containers in each processed image is obtained from simple data such as the color of the upper surfaces of the containers and the dimensions of the upper surfaces of the containers. The method enables the positions of the containers to be obtained reliably, without necessitating annotation of the position of similar containers in similar images, in contrast to the prior art.

In accordance with additional non-limiting features the image is obtained by at least one video camera a field of view of which is directed toward the plurality of containers.

In accordance with additional non-limiting features the method further includes, after combining the masked image and the local binary patterns:
at least one expansion of the sets of pixels representing the upper faces of the containers,
at least one erosion of the sets of pixels representing the upper faces of the containers.

In one embodiment, the method includes:
a first expansion of the sets of pixels representing the upper faces of the containers, then
a first erosion of the sets of pixels representing the upper faces of the containers, then
a second expansion of the sets of pixels representing the upper faces of the containers.

In one embodiment the position of each upper face obtained includes coordinates of the center of gravity of the upper face in the image.

In one embodiment the combination of the masked image and the local binary patterns is produced by multiplication of a first matrix by a second matrix, the first matrix representing the masked image and the second matrix representing the local binary patterns.

In one embodiment the predefined size of the upper face and the predefined color of the upper face are obtained via a human-machine interface before obtaining local binary patterns and before applying a color mask to the acquired image.

In one embodiment the predefined size of the upper face and the predefined color of the upper face are stored in a database.

In one embodiment, before calculating the dimension of the upper face, the predefined size of the upper face of the container is transformed into a size of the upper face of the container in pixels of the acquired image on the basis of a predefined distance between the video camera and the upper face of the containers and a predefined resolution in pixels of the video camera.

Another aspect of the invention concerns a computer program product including instructions which when the program is executed by a computer cause the latter to execute the method according to the invention.

Another aspect of the invention concerns a computer-readable storage medium containing instructions which when they are executed by a computer cause the latter to execute the method according to the invention.

The invention and its various applications will be better understood after reading the following description and examining the accompanying figures.

### BRIEF DESCRIPTION OF THE FIGURES

The figures are non-limiting depictions of the invention.

FIG. 1 shows a schematic representation of a packaging line in which the method according to the invention is used,

FIG. 2 shows a schematic representation of the method according to the invention,

FIG. 3 shows a schematic representation of results of steps of the method according to the invention,

FIGS. 4a and 4b show schematic representations of containers the position of which can be obtained by the method according to the invention,

FIG. 5 shows a schematic representation of one step of the method according to the invention.

### DETAILED DESCRIPTION

Unless otherwise specified, the same element appearing in different figures has only one reference.

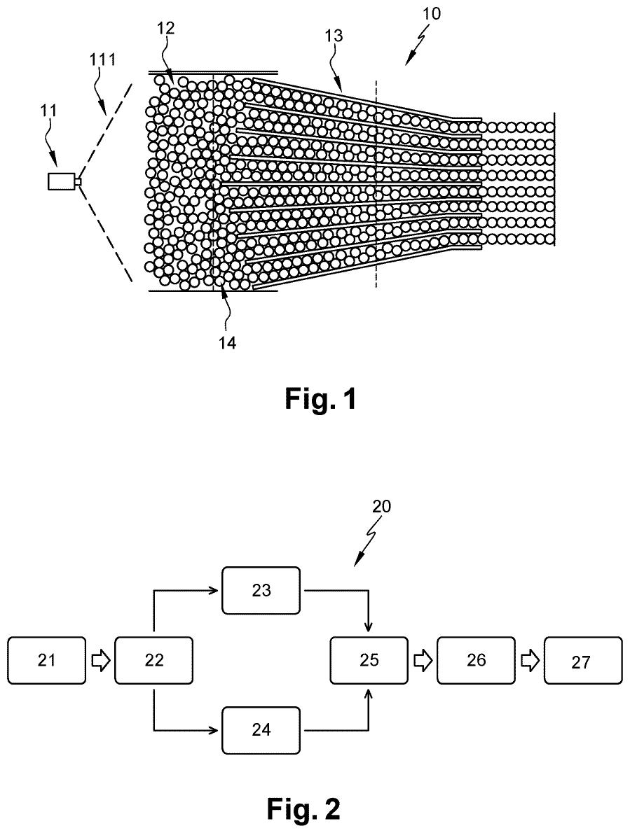

FIG. 1 shows a diagrammatic representation of a packaging line in which the method according to the invention can be used.

The method according to the invention represented schematically in FIG. 2 enables detection of the position of containers on a packaging line for example.

Such a packaging line is for example the packaging line 10 in FIG. 1. The packaging line 10 includes a belt 12, a set of corridors 13 and a plurality of containers 14. The containers 14 circulate upright, that is to say resting on their bottom and with an upper face free. The belt 11 enables the containers 14 to be moved in and outside the corridors 13. The invention applies to any packaging line and is not limited to packaging lines of the same type as the packaging line shown in FIG. 1.

When the invention is applied to the packaging line 10 the packaging line 10 is equipped with a video camera 11. The video camera 11 is an image capture device and can be of any type. The video camera 11 preferably includes an image sensor, for example of CCD or CMOS type, and optical means adapted to redirect incident light beams toward the image sensor. The video camera 11 therefore has a field of view 111 defined in particular by the dimensions of its sensor and by the dimensions and type of its optical means. This field of view 111 is directed toward the containers 14 circulating in or on the packaging line. By “directed toward the container” is meant that at least a part of the containers 14, preferably most of the containers 14 circulating at a given position, is or are imaged on the sensor of the video camera 11. In other words, at all times at least some of the containers 14, preferably a majority of the containers 14 circulating at a given position, are present in an image obtained by the video camera 11 at the given time.

The method 20 according to the invention is represented schematically in FIG. 2. The method 20 is a method executed by a computer for detecting the position of a plurality of containers.

The method 20 can be executed by computer or by a processor. By “executed by computer” is meant that the steps or at least one step are or is executed by at least one computer or processor or other similar system. Thus steps are executed by the computer or processor, possibly entirely automatically or semi-automatically. In examples at least some of the steps of the method can be triggered by user-computer interaction. The required level of user-computer interaction can depend on the intended level of automation and balanced with the necessity to meet the requirements of the user. In examples this level can be defined by the user and/or predefined.

A typical example of computer execution of a method consists in executing the method using a system adapted to that end. The system can include a processor coupled to a memory and a graphical user interface (GUI), the memory storing a computer program including instructions for executing the method. The memory can equally store a database. The memory is any hardware suitable for such storage, possibly comprising a plurality of distinct physical parts.

The method 20 includes a first step 21 of acquiring at least one image of a plurality of containers 14. The position of the plurality of containers 14 obtained at the end of the method is the position of the containers 14 included in the image, that is to say of the containers 14 represented in the form of pixels in the image. The image comprises a plurality of pixels. The image can be obtained by the processor or the computer executing the method 20 directly from the output of a video camera 11 or from a local or remote database that is not represented. The image can be acquired by the processor or the computer via a wired or wireless connection. The image is preferably acquired in digital form. The image has been produced beforehand by the video camera 11. The containers 14 in the image must be seen in a low angle shot, which is to say that at least one predefined upper surface of the containers 14 must be visible. To this end, the video camera must be placed at a height relative to the surface on which the containers 14 rest greater than the height of the containers 14.

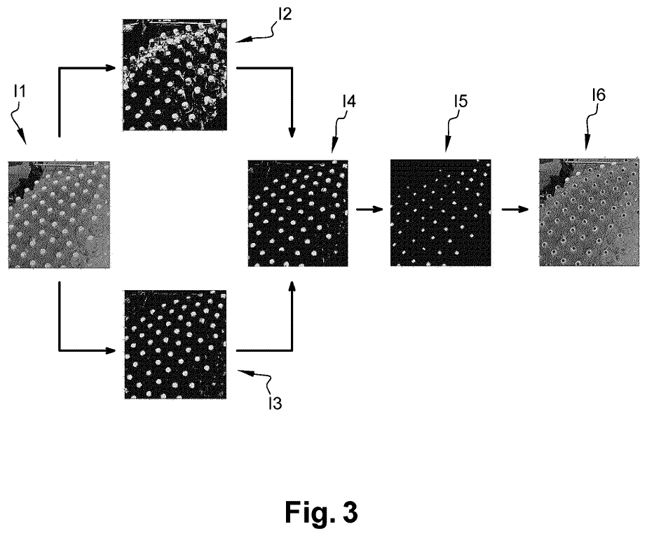

The acquired image, for example the image 11 shown in FIG. 3, includes a plurality of containers 14 in the form of bottles, each bottle including a substantially circular white cap.

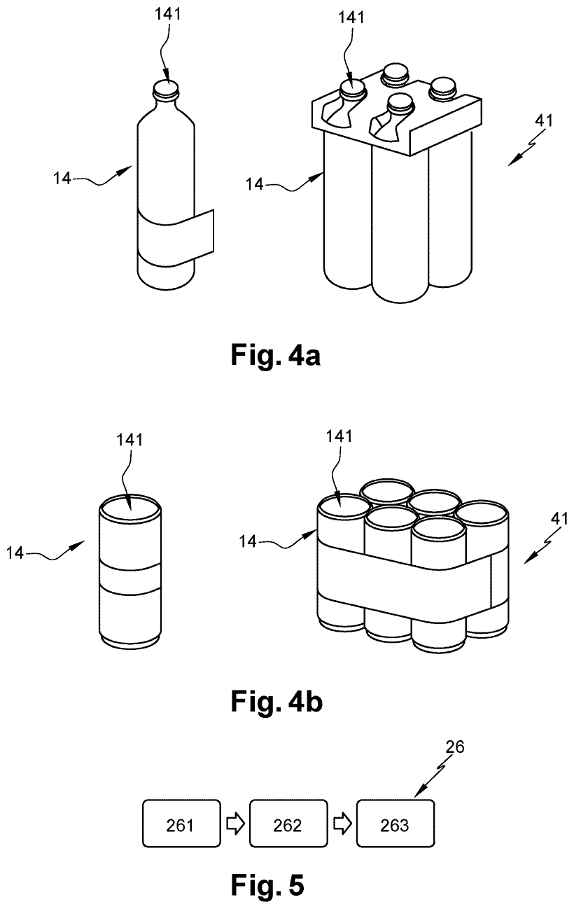

By “upper surface of the containers” is meant at least one end of the containers 14. For example, as represented in FIG. 4a, when the container 14 is a bottle the upper surface of the bottle is the upper surface 141, that is to say the surface of the cap of the bottle when the bottle is seen from above. For example, as represented in FIG. 4b, when the container 14 is a can, the upper surface of the can is the upper surface 141, that is to say the surface that is visible when the can is seen from above. For example, when the container 14 is a carton or a tin the upper surface of the carton or the tin is the upper surface 141, that is to say the surface visible when the carton or the tin is seen from above.

Similarly, the plurality of containers 14 can form batches. When the containers 14 form batches 41 the upper surface of the batch 41 is the surface visible when the batch 41 is seen from above. When the containers 14 form batches the upper surface can be the upper surface of each container 14 in the batch 41.

The upper surface of a container 14 is generally the highest surface of the container 14 that is substantially plane or can be approximated by a substantially plane shape, for example a disc or a solid rectangle. An upper surface is preferably a surface in a horizontal plane, that is to say in a plane substantially parallel to the bottom of the container 14 on which the container 14 is resting and therefore substantially parallel to the surface on which the container 14 is resting. The “highest” surface is to be understood as the surface that is the highest relative to the bottom of the container 14.

The method then includes a step 22 of acquiring a size of the upper surface of the containers 14 and a color of the upper surface of the containers 14. This implies that the position of the containers in the image acquired in step 21 obtained at the end of the method 20 is the position of the containers in the image having an upper surface of the acquired size and the acquired color.

The upper surface size and the upper surface color are acquired by the processor or the computer executing the method 20 from a remote and/or local database or directly from a human-machine interface.

The size of the upper surface of the containers 14 is defined for example in centimeters or in millimeters. The size of the upper surface is for example one dimension of the upper surface of the containers 14. A dimension of the upper surface of the containers 14 is for example a diameter of the upper surface 141, for example when the upper surface is the upper surface of a bottle or any container of circular, oval, substantially circular or substantially oval shape, for example a cap diameter when the upper surface is the upper surface of a cap of a bottle 14. A dimension of the upper surface of the container 14 is for example a width or a length of the upper surface 141, for example when the upper surface is the upper surface of a carton or of any container of rectangular or substantially rectangular shape.

The color of the upper surface of the containers 14 is for example defined in the RGB or YCbCr format or any other color format. The color of the upper surface is a majority color of the upper surface, the majority color being defined in terms of area. For example, for containers 14 that are bottles with blue caps, the color of the upper surface acquired is blue. The color can be from a range of colors.

The size and the color of the upper surface of the containers the position of which is to be acquired are predefined, that is to say defined before the method 20 commences and/or before their use by the method 20. For example, the size and the color of the upper surface of the containers can be defined by an operative using a human-machine interface such as a touch-sensitive screen or a computer including a screen and means for entering data into the computer, for example a keyboard and/or a mouse. After definition thereof by an operative, the size and the color of the upper surface of the containers 14 can be stored in a database accessible by the processor and/or the computer executing the method 20. Alternatively, the human-machine interface can be directly accessible by the processor and/or the computer executing the method 20 to obtain the upper surface size and color data.

Thanks to the invention, changing the containers the position of which is to be acquired is therefore easy, cap color and size information then being simply entered by an operative and/or recovered automatically without necessitating long and complex training or annotation of data, in contrast to the prior art.

Once the size and the color of the upper surface of the container have been obtained in step 22 the size of the upper surface in pixels has to be obtained. If the size of the upper surfaces was already indicated in pixels, the method continues with step 23. On the contrary, if the size of the upper surfaces is indicated in a unit other than pixels, the size must be converted to pixels. This conversion is carried out knowing the definition of the image obtained by the video camera 11 in pixels (and therefore the resolution of the sensor of the video camera 11) and the distance between the video camera 11 and the containers 14.

The method 20 then includes two steps 23 and 24 that can be carried out simultaneously or sequentially in either order. The steps 23 and 24 enable identification and extraction of characteristics of the image. Step 23 enables identification and extraction of shape characteristics of the image I1 and step 24 enables identification and extraction of color characteristics of the image I1.

Step 23 is a step of calculating local binary patterns of the image acquired on the basis of a dimension of the upper surface of each container of the plurality of containers, the dimension of the upper surface of each container being calculated on the basis of a predefined upper surface size of the containers. When the predefined upper surface size of the containers 14 is equal to the predefined upper surface dimension, the latter is directly used in the calculation of the local binary patterns. The predefined upper surface dimension is for example the radius, diameter, width or length of the upper surface.

Calculation of the local binary patterns includes the use of a local binary pattern (LBP) algorithm. The dimension of the upper surface obtained from the size acquired in step 22 is used to define the vicinity of each pixel in terms of a number of pixels. The vicinity is used to compare the level of luminance of a central pixel relative to the level of luminance of its neighbor pixels in its vicinity. For each so-called “central” pixel a value is assigned that corresponds to a series of digits (preferably ‘0’or ‘1’), each digit in the series of digits corresponding to a level of luminance of a pixel in the vicinity of the central pixel. A histogram is then calculated for the frequency of appearance of each digit or number (preferably ‘0’or ‘1’) in said vicinity, that is to say each combination of pixels having a level of luminance less than or greater than the central pixel. This histogram can be considered as a characteristics vector. Concatenation of the histograms of all the vicinities in the image enables local binary patterns to be obtained. The invention can be executed with any algorithm enabling local binary patterns to be obtained. An example of an image with local binary patterns is represented in FIG. 3 (image I2).

Step 24 is a step of masking the image obtained in step 21 using a color mask. Such a color mask enables modification of the value of all the pixels having a color the same as or close to the predefined color or contained in a range of colors around the predefined color or included in the predefined range of colors, and/or modification of the value of all the pixels having a color different from the predefined color not included in a range of colors around the predefined color or not included in the predefined range of colors. For example, if the chosen color is white all the white pixels can remain white and all the non-white pixels can take a similar value different from the value corresponding to the color white. The invention can use any known color mask. The image obtained is termed masked or “partially” masked in that only one color is masked. By “masked” is meant the application of a mask, whether it is a mask that reduces the presence of the predefined color or a mask that attenuates it. A color mask enables easy identification of all the pixels having the predefined color. An example of a partially masked image obtained in this way is represented in FIG. 3 (image I3).

The images I2 and I3 obtained are then combined in a step 25. To this end, in each step 23 and 24 the image obtained is a digital image in the form of a matrix. The combination of the two images is preferably a multiplication of matrices. The image I4 resulting from the combination of the images I2 and I3 therefore includes color and shape information extracted from the image I1. This taking into account two types of characteristics enables improved detection of the upper surfaces of the containers and at least partial elimination of noise. By “noise” is meant the parts of the extracted image apparently corresponding to an upper surface of the container but in reality not corresponding thereto. For example, noise can be created by objects the same color as the predefined color but not being a container upper surface.

For further reduction of noise an optional step 26 can be executed after the combination of the images I2 and I3 in step 25 to obtain the image I4.

The optional step 26 is represented in FIG. 5 and preferably comprises three substeps 261 to 263. The step 26 is applied to sets of pixels obtained from the image I4, that is to say resulting from the combination of the images I2 and I3.

In step 26 a succession of erosions and expansions of the sets of pixels obtained from the combined image are carried out. The erosions and expansions carried out are preferably the following:
a first erosion 261,
a first expansion 262,
a second erosion 263.

This succession of erosions and expansions makes it possible to eliminate detections of small size and thus to reduce noise. This improves the detection of the upper surfaces.

By “erosion” is meant preserving, for an image, only the pixels for which a chosen pattern termed the “core” is included in the image. Thus the image is shrunk.

By “expansion” is meant replacing each pixel by a chosen pattern termed the “core”. Thus the image is enlarged depending on the core.

By applying erosion and expansion each set of pixels obtained from the image 14 sets of pixels that are too small, that is to say pixels having a size less than the predefined upper surface size, are eliminated. Indeed, during the first erosion 261 all the pixels of a set of pixels can have been eliminated, for example if not all of the core has been included in the set of pixels. The resulting sets of pixels are thereafter expanded in a substep 262 to take on a larger size that is still less than their original size. Finally a second erosion eliminates the sets of pixels that are too small. Indeed, during the second erosion 261 all the pixels of a set of pixels can have been eliminated, for example if the whole of the core cannot be included in the set of pixels after expansion.

This results in a plurality of sets of pixels in the image I5 corresponding to upper surfaces of containers 14. For example, the pixels of the image I5 that do not form pixels of the plurality of sets of pixels can be assigned a predetermined value different from the pixels of the plurality of sets of pixels, for example the value 0.

Any algorithm for extraction of sets of similar pixels can be used to extract the sets of pixels from the image 15, for example a so-called “label features” algorithm.

The method 20 finally includes a final step 27 of calculating centers of gravity of the sets of pixels in the image I5 to obtain the position of each container 14 in the image acquired in step 21. This calculation step enables the coordinates of the containers 14 in the image to be obtained. To calculate the center of gravity of each set of pixels the mean value of the coordinates of the pixels of that set of pixels can be used to obtain the center of gravity of that set of pixels.

The coordinates obtained in this way can then be transformed into coordinates relative to the packaging line 10 to position each container 14 relative to the packaging line 10 and not relative to the video camera 11. The coordinates relative to the packaging line 10 can then be used to detect and/or to predict the formation of jams in the packaging line, for example by calculating the speed of the containers 14 and their position on the basis of successive images at successive moments. To this end the method 20 can be repeated at predefined time intervals, for example every 0.2 seconds with a conveyor speed of 300 millimeters per second for a 60 millimeter bottle.

1. A computer-implemented method of detecting the position of a plurality of containers, each container comprising an upper surface, the method comprising:
acquiring at least one image of the plurality of containers to form an acquired image;
obtaining local binary patterns of the acquired image on the based on a dimension of the upper surface of each container of the plurality of containers, the dimension of the upper surface of each container being calculated based on a predefined size of the upper surface of the containers;
applying a color mask to the acquired image on a predefined color of the upper surface of the containers to obtain a partially masked image;
combining the partially masked image and the local binary patterns to obtain sets of pixels representing the upper surfaces of the containers; and
calculating centers of gravity of the sets of pixels to obtain a position of each upper surface of the containers.

2. The method as claimed in claim 1, wherein the at least one image is obtained by at least one video camera having a field of view is directed toward the plurality of containers.

3. The method as claimed in claim 1, further comprising, after combining the masked image and the local binary patterns:
at least one expansion of the sets of pixels representing the upper surfaces of the containers; and
at least one erosion of the sets of pixels representing the upper surfaces of the containers.

4. The method as claimed in claim 3, further comprising:
a first expansion of the sets of pixels representing the upper surfaces of the containers, then
a first erosion of the sets of pixels representing the upper surfaces of the containers, then
a second expansion of the sets of pixels representing the upper surfaces of the containers.

5. The method as claimed in that claim 1, wherein the position of each upper surface obtained comprises coordinates of the center of gravity of the upper surface in the image.

6. The method as claimed in claim 1, wherein the combination of the partially masked image and the local binary patterns is produced by multiplication of a first matrix by a second matrix, the first matrix representing the partially masked image and the second matrix representing the local binary patterns.

7. The method as claimed in claim 1, wherein the predefined size of the upper surface and the predefined color of the upper surface are obtained via a human-machine interface before obtaining the local binary patterns and before applying a color mask to the acquired image.

8. The method as claimed in claim 1, wherein the predefined size of the upper surface and the predefined color of the upper surface are stored in a database.

9. The method as claimed in claim 1, wherein, before calculating the dimension of the upper surface , the predefined size of the upper surface of the container is transformed into a size of the upper surface of the container in pixels of the acquired image on the basis of a predefined distance between the video camera and the upper surface of the containers and a predefined resolution in pixels of the video camera.

10. (canceled)

11. A computer-readable storage medium containing instructions, wherein when the instructions are executed by a computer, the instructions cause the computer to execute a method, the method comprising:
detecting a position of a plurality of containers, each container comprising an upper surface, the detecting comprising:
acquiring at least one image of the plurality of containers to form an acquired image;
obtaining local binary patterns of the acquired image based on a dimension of the upper surface of each container of the plurality of containers, the dimension of the upper surface of each container being calculated based on a predefined size of the upper surface of the containers;
applying a color mask to the acquired image based on a predefined color of the upper surface of the containers to obtain a partially masked image;
combining the partially masked image and the local binary patterns to obtain sets of pixels representing the upper surfaces of the containers; and
calculating centers of gravity of the sets of pixels to obtain a position of each upper surface of the containers.

12. The method as claimed in claim 2, further comprising, after combining the masked image and the local binary patterns:
at least one expansion of the sets of pixels representing the upper surfaces of the containers; and
at least one erosion of the sets of pixels representing the upper surfaces of the containers.
